(19) United States
(12) Patent Application Publication
(10) Pub. No.: US 2008/0017703 A1
(43) Pub. Date: Jan. 24, 2008

(54) Smart card capable of processing financial transaction messages and operating method therein

(75) Inventors: Zhou Lu, Beijing (CN); Huazhang Yu, Beijing (CN)

Correspondence Address: SCULLY SCOTT MURPHY & PRESSER, PC, 400 GARDEN CITY PLAZA, SUITE 300, GARDEN CITY, NY, 11530, US

(73) Assignee: Feitian Technologies, Co., Ltd., Beijing (CN)

(21) Appl. No.: 11/821,027

(22) Filed: Jun. 21, 2007

(30) Foreign Application Priority Data
Jun. 22, 2006 (CN) 200610086565.1

(51) Int. Cl. G06Q 40/00; G06K 19/00

(52) U.S. Cl. 235/379; 235/487

(57) ABSTRACT

In one aspect of the present invention, there is provided a smart card capable of processing financial transaction messages, comprising a CPU controller module, a security controller module, an input/output (I/O) interface module, a storage module, a financial card standard data processor module, and an ISO 8583 message processor module; the CPU controller module is coupled to and controls the security controller module, the input/output (I/O) module, the storage module, the financial card standard data processor module, and the ISO 8583 message processor module. In another aspect of the present invention, there is provided an operating method of the smart card, comprising the steps of processing financial card standard related data and processing ISO 8583 message data. By integrating the feature of processing ISO 8583 message into the smart card, the security for electronic financial transactions is improved, and it is possible that the smart card is processed by the personal computer, which is helpful to financial transactions of the card holder.

### FIELD OF THE INVENTION

The present invention relates to an electronic financial transaction system, and more particularly, to a smart card capable of processing financial transaction messages and operating method therein.

### BACKGROUND OF THE INVENTION

With prevalent electronization of financial transactions, smart cards are used in a wider range of applications. A smart card, also known as an integrated circuit (IC) card, comprises a plastic substrate and an IC chip, which is embedded into the plastic substrate. It looks like a magnetic card with a magnetic strip. The smart card has been widely used for its small form factor, sophisticated IC chip technology, special confidentiality and security features since it was introduced. In some areas, the smart card provides only protected non-volatile memory. Advanced smart cards have a microprocessor and a memory for secure and storage purposes, and can be used in security applications using public keys or shared keys algorithms. The non-volatile memory in the smart card stores keys and digital certificates. Some smart cards have a cryptographic coprocessor and support cryptographic algorithms, such as RSA, DES and 3DES. Generally, the smart card is not provided with a battery and is activated only when it is inserted into a reader. When inserted into a reader, it goes into an inactive status after a reset sequence, and waits for requests from the applications of clients (or hosts). Smart cards are divided into two types: contact and contactless. Contact smart cards have 8 contacts to communicate with the reader. Contactless smart cards communicate using RF (Radio Frequency) signal within 2 feet (60.96 cm) or less range. The RF communication is based on the RFID (Radio Frequency Identification) technology. Following the rapid development of technology, the smart card can now be integrated into portable devices, such as the mobile phone, PDA, Pocket PC, USB Token, USB micro drive, MP3 player and removable memory. Currently, the smart card is widely used for telephone and financial transactions and identification etc.

To standardize the smart card, ISO (International Organization for Standardization) produces a series of standards. ISO 7816-3 regulates the power supply, signal structure and data exchange between the smart card and the interface device (e.g. a terminal), including signal rate, voltage level, current value, odd/even convention, operating procedure, transfer mechanism, and communication with the smart card. This standard ensures that the data is transmitted between the smart card and the terminal properly, and prevents the communication data from being intercepted and tampered.

The EMV standard is introduced by three world-leading credit card organizations—Europay, MasterCard and VISA, to specify a unified technique standard for bank chip cards. EMV standard compliant bank cards have strong fraud protection as it is almost impossible the personal information stored thereon is reproduced. Compared to the magnetic card, the information stored on the EMV compliant chip card is protected from malicious destruction and theft in a more secure manner. Coded information in the chip is helpful to mitigate risks of card holders, merchants and banks. Moreover, the chip card can also store other information, such as membership, credited scores, even diet habits and health condition.

China Financial Integrated Circuit (IC) Card Spec (“PBOC standard” hereinafter) as a financial industry standard in China is established in accordance with the EMV standard, taking into consideration the possible demands for financial IC cards in China. The up-to-date version of this standard is PBOC 2.0.

The ISO 8583 standard specifies the specification for data exchange and secure and confidential data interfaces between bank card application systems. The message transmitted between the bank card data center and the terminal, such as an ATM or EFT/POS, is defined by ISO 8583: 2003 BANK CARD ORIGINATED MESSAGES—INTERCHANGE MESSAGE SPECIFICATIONS—CONTENT FOR FINANCIAL TRANSACTIONS. The standard regulates that the message is comprised of up to 128 fields. Each field has a specific form. The length for each field is either fixed, or variable. An ISO 8583 message contains 3 components: a MESSAGE-TYPE-IDENTIFIER, a BITMAP, and a set of data elements specified by BITMAP. The BITMAP is a key to packing and unpacking of the message.

For existing art, the financial smart card processes EMV/PBOC standard related data, while the financial transaction terminal works on the ISO 8583 message, and then connects to and interacts with the service provider via networks. The transaction security depends in a large part on the security of the terminal, which might bring risks in case it has security holes and the holes are utilized. Furthermore, the financial smart card can only be processed by the terminal, limiting the applications of the card.

### SUMMARY OF THE INVENTION

The present invention provides a smart card capable of processing financial transaction messages and method therein. The smart card is able to process the ISO 8583 messages.

In one aspect of the present invention, there is provided a smart card capable of processing financial transaction messages, comprising a CPU controller module, a security controller module, an input/output (I/O) interface module, a storage module, a financial card standard data processor module, and an ISO 8583 message processor module; the CPU controller module is coupled to and controls the security controller module, the input/output (I/O) interface module, the storage module, the financial card standard data processor module, and the ISO 8583 message processor module which organizes and packs the raw input data, and unpacks and processes the received ISO 8583 message packet.

Optionally, the smart card is contact or contactless.

Optionally, the smart card is integrated into a portable device.

Optionally, the portable device is a mobile phone, a PDA (Personal Digital Assistant), a pocket PC, a USB Token, a USB micro drive, an MP3 player or a removable memory.

In another aspect of the present invention, there is provided an operating method of the smart card capable of processing financial transaction messages, comprising the steps of:
1) processing financial card standard related data internally;
2) acquiring transaction data;
3) generating an uploading message;
4) sending the message to a financial transaction terminal; and
5) forwarding the message to the system of the service provider.

Optionally, the method also comprises the steps of:
1) acquiring a message packet returned from the system of the service provider and the financial transaction terminal;
2) resolving the message;
3) resolving the transaction data;
4) extracting necessary information and transferring it to the terminal as output; and
5) updating the internal data of the card.

The said financial card standard is EMV/PBOC standard; and the said financial card standard related data is EMV/PBOC standard related information.

The said message is an ISO 8583 message.

By integrating the feature of processing ISO 8583 message into the smart card, the security for electronic financial transactions is improved, and it is possible that the smart card is processed by the personal computer, which is helpful to financial transactions of the card holder.

### BRIEF DESCRIPTION OF THE DRAWINGS

The present invention may be further understood from the following description in conjunction with the appended drawings. In the drawings:

FIG. 1 is a schematic of the application model of the existing art;

FIG. 2 is a schematic of the application model of the present invention;

FIG. 3 is a schematic of an embodiment of the present invention;

FIG. 4 is a schematic of another embodiment of the present invention;

FIG. 5 is a schematic of the smart card of the present invention;

FIG. 6 is a flow diagram of packing the message data;

FIG. 7 is a flow diagram of unpacking the message packet.

### DETAILED DESCRIPTION OF THE PREFERRED EMBODIMENTS

The present invention is further described with the embodiments and the drawings below.

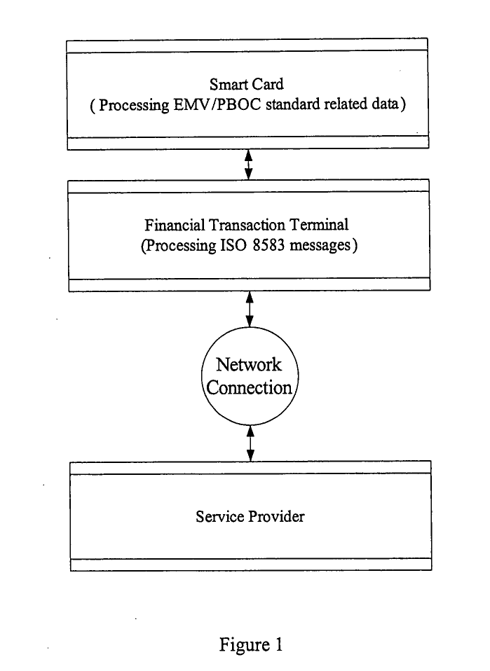

Referring to FIG. 1, the financial smart card currently is responsible for processing EMV/PBOC standard related data. The financial transaction terminal is responsible for processing ISO 8583 message data, and communicating with the system of the service provider when the smart card is coupled to it.

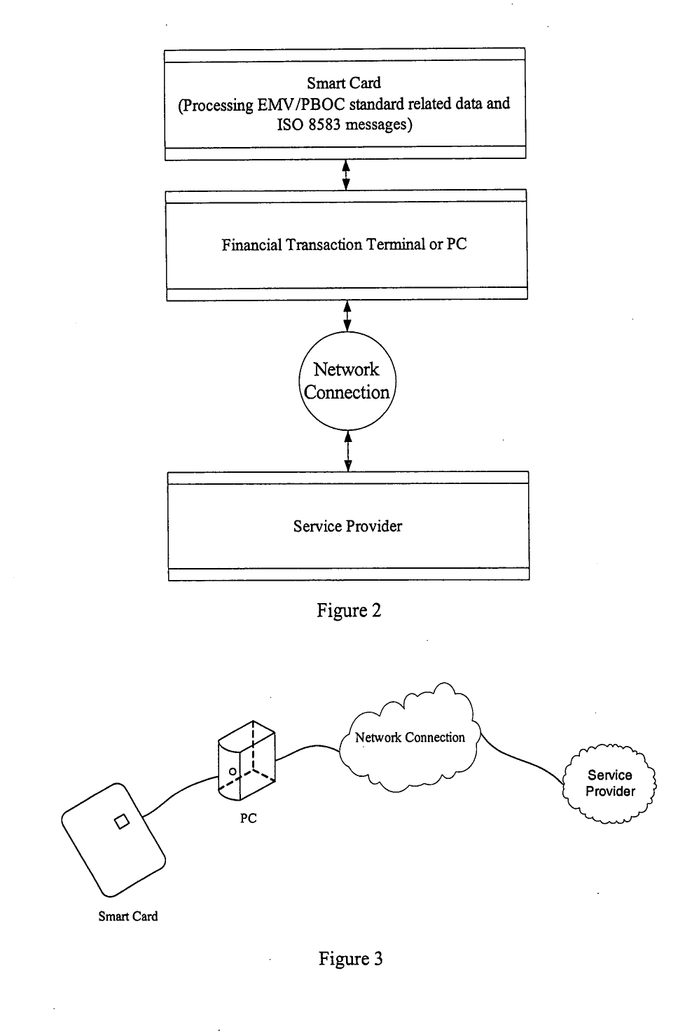

Referring to FIG. 2, the smart card of the present invention is responsible for processing both EMV/PBOC standard related data and ISO 8583 message data so that the smart card can be coupled to not only the financial transaction terminal but the personal computer (PC) for financial purpose. By this way, the card holders are able to use their cards at any places where there is a financial transaction terminal or a PC which is adapted to process the smart card. And more important, financial transaction security is improved.

Referring to FIG. 3, the smart card is coupled to a PC (or a financial transaction terminal), which is connected to the system of the service provider via the network connection. The smart card is responsible for processing both EMV/PBOC standard related data and ISO 8583 message data. The smart card first processes the message information, including the sender, receiver, amount, and transaction serial number, and then sends the information to the PC, which will forward that information to the system of the service provider via a network connection. The smart card is contact, or contactless (with an internal antenna). To process the smart card, the PC must at least be equipped with a reader or other device capable of writing and reading from the smart card. The keyboard of the PC can be used to enter the transaction information by the card holder.

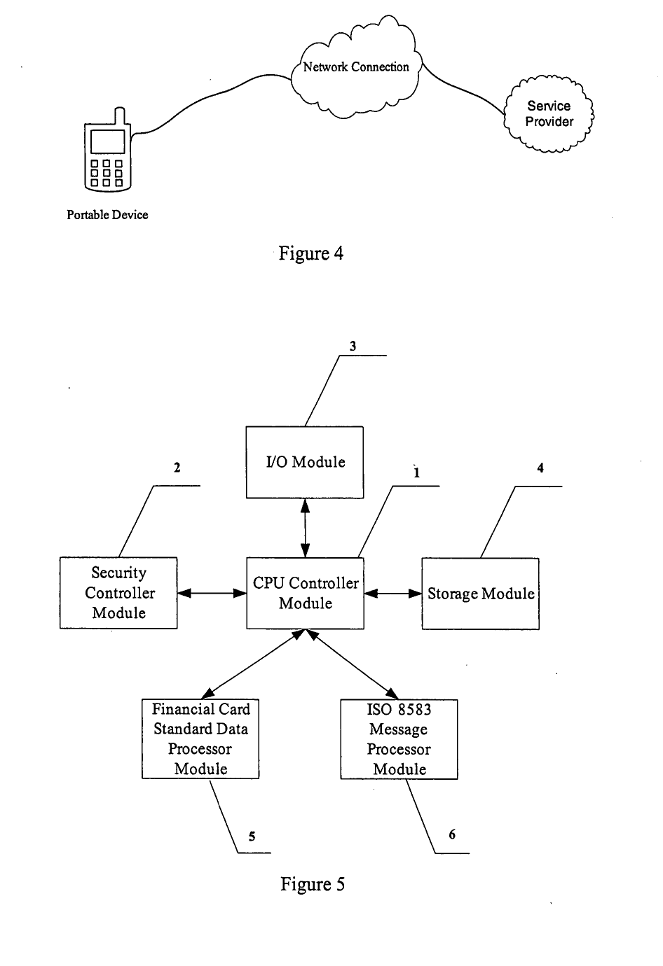

Referring to FIG. 4, the smart card is integrated into a portable mobile device (e.g. a mobile phone), which is connected to the system of the service provider via the wireless network. The smart card functions and appears like a SIM card in the mobile phone. The portable mobile phone functions as a terminal. The smart card is responsible for processing both EMV/PBOC standard related data and ISO 8583 message data. The smart card first processes the message information, including the sender, receiver, amount, and transaction serial number, and then sends the information to the portable mobile device, which will forward that information to the system of the service provider via a wireless network connection. The mobile device is capable of reading information from the smart card and sending it to the service provider, or receiving and processing information from the service provider. The card holder inputs information or instructions with the buttons, stylus or voice sensitive feature of the mobile device. The transaction result could be presented on the display of the mobile device.

Optionally, the mobile device is connected to a PC in a wired or wireless manner, and connected to the system of the service provider via a network connection.

Referring to FIG. 5, the smart card capable of processing financial transaction messages of the present invention comprises a CPU Controller Module (1), a Security Controller Module (2), an Input/Output (I/O) Interface Module (3), a Storage Module (4), a Financial Card Standard Data Processor Module (5) and an ISO 8583 Message Processor Module (6). The Security Controller Module (2), Input/Output (I/O) Interface Module (3), Storage Module (4), Financial Card Standard Data Processor Module (5) and ISO 8583 Message Processor Module (6) are coupled to the CPU Controller Module (1) respectively. The smart card works with a Card Operating System (COS) firmware. The medium of the Storage Module (4) is EEPROM or flash memory, or the like, which is used to store the private data of the card holder, such as personal ID number, bank account number, and/or expiration data etc. The Financial Card Standard Data Processor Module (5) is adapted to process EMV/PBOC standard related information. The ISO 8583 Message Processor Module (6) is adapted to organize and pack the raw input data, and send the ISO 8583 message packet to the service provider by communication means, or vice versa. Application Protocol Data Unit (APDU) contains a set of instructions for operating the smart card. For the present invention, the extension of APDU instruction set is required to support ISO 8583 message processing inside the smart card. For example, the instructions for packing and unpacking the ISO 8583 message inside the smart card should be added.

The MESSAGE-TYPE-IDENTIFIER is a field of a number of 4 digits. It indicates the transaction type for the message. For example:
0100 Auth. Class Request Message (Auth., Auth. Revocation; Balance Inquiry)
0110 Auth. Class Response Message (Auth., Auth. Revocation; Balance Inquiry)

The BITMAP indicates the format of the message. A bit of “1” or “0” indicates if the corresponding data element exists or not for indexing subsequent data. If the first bit of BITMAP is set to “1”, the Extended BITMAP (128 fields) should have been used; or the Basic BITMAP (64 fields) is used. For Auth./Auth. Revocation class transactions, only the Basic BITMAP should be used. In this case, the first bit is set to “0”.

The data elements defined by ISO 8583 standard are (A) alphabetic, (B) binary, and so on. For details on these data elements, see related documentation on ISO 8583 standard. The basic data types may be combined as required in applications to produce a new data type.

To implement ISO 8583 standard by programming:
1) Data element type description—Use a class, ISO_{—}8583, to describe the properties of a data element in accordance with the ISO 8583 standard;
2) Data element definition—To implement a generic packing/unpacking interface, use a generic data element type, which covers all potential types of 128 data elements in the ISO 8583 standard, when defining the data elements;
3) Message processing—Provide a set of functions to pack and resolve ISO 8583 messages. Processing messages with the class ISO_{—}8583_MESSAGE streamlines ISO 8583 message operations, and provides applications with a generic packing/unpacking interface. Packing and unpacking are nearly two mutually reversible procedures in programming. When unpacking: first preprocess the message packet, by removing the MESSAGE-TYPE-IDENTIFIER and the BITMAP from the message, and saving the remaining part as an intact string to a predefined storage area for saving unpacked data. However, unpacking is not done after that. It is started only when a specific application needs access to the data elements. But the processing functions resolve only the interest fields for that application.

A transaction based on the smart card and the method of the present invention would be done as follows: a smart card or a portable mobile device with a smart card receives the raw data, performs primary check on validity and pre-process, generates a transaction request message, and transmits the message to the system of the service provider; the system then processes in response to the request, and returns the result to the terminal (coupled to the smart card) and the smart card.

Packing and unpacking the ISO 8583 messages are done within the smart card.

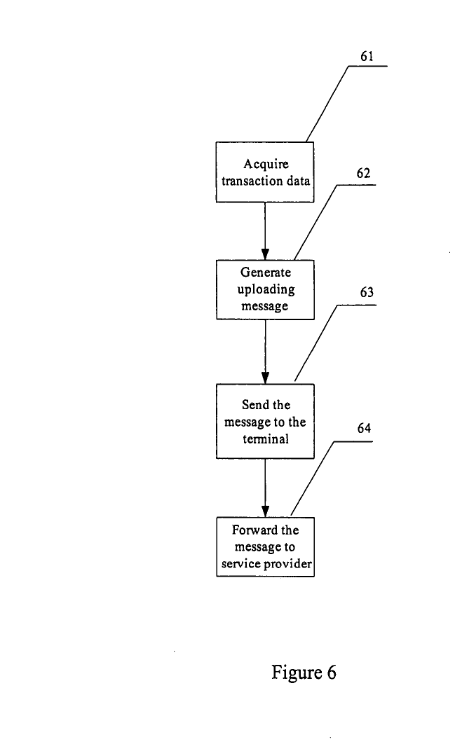

Referring to FIG. 6, the flow of packing an ISO 8583 message is described. First, acquire the transaction data (which is entered by the card holder and/or generated by the system) including detailed transaction information in Step 61; then generate an uploading message in Step 62, comprising the substeps of forming BITMAP, filling out transaction data fields, and evaluating Message Authentication Code (MAC) fields; then send the message to the financial transaction terminal in Step 63; finally, forward the message to the system of the service provider in Step 64.

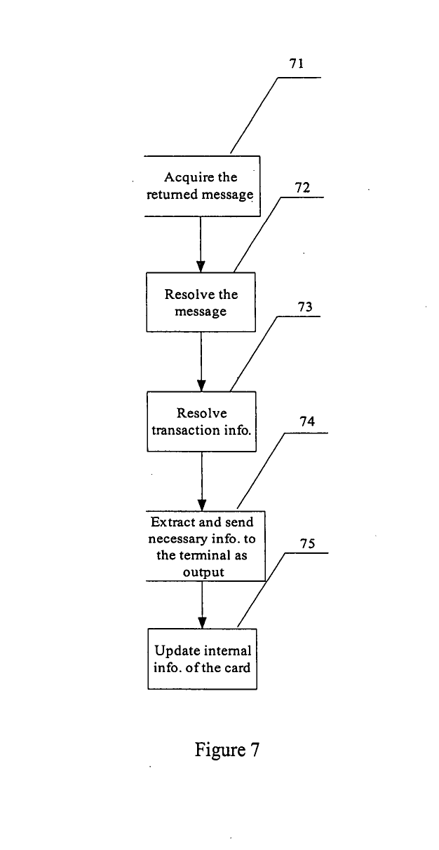

Referring to FIG. 7, the flow of unpacking an ISO 8583 message packet is described. First, acquire the message packet returned from the financial transaction terminal and the system of the service provider in Step 71; then resolve the message in Step 72, comprising the substeps of resolving BITMAP, verifying MAC fields; then resolve the transaction data in Step 73; then extract necessary information and transfer it to the terminal as output in Step 74; finally, update the internal data of the smart card and display the result on the terminal in Step 75.

It will be appreciated by those of ordinary skill in the art that the invention can be embodied in other specific forms without departing from the spirit or essential character thereof. The presently disclosed embodiments are therefore considered in all respects to be illustrative and not restrictive. The scope of the invention is indicated by the appended claims rather than the foregoing description, and all changes which come within the meaning and range of equivalents thereof are intended to be embraced therein.

1. A smart card capable of processing financial transaction messages, comprising a CPU controller module, a security controller module, an input/output (I/O) interface module, a storage module, a financial card standard data processor module, and an ISO 8583 message processor module; the CPU controller module is coupled to and controls the security controller module, the input/output (I/O) module, the storage module, the financial card standard data processor module, and the ISO 8583 message processor module which organizes and packs the raw input data, and unpacks and processes received ISO 8583 message packet.

2. The smart card of claim 1, wherein the smart card is contact or contactless.

3. The smart card of claim 1, wherein the smart card is integrated into a portable device.

4. The smart card of claim 3, wherein the portable device is a mobile phone, a PDA (Personal Digital Assistant), a pocket PC, a USB Token, a USB micro drive, an MP3 player or a removable memory.

5. An operating method of the smart card capable of processing financial transaction messages, comprising the steps of:
1) processing financial card standard related data internally;
2) acquiring transaction data;
3) generating an uploading message;
4) sending the message to a financial transaction terminal; and
5) forwarding the message to the system of the service provider.

6. The method of claim 5, wherein the method also comprises the steps of:
1) acquiring a message packet returned from the system of the service provider and the financial transaction terminal;
2) resolving the message;
3) resolving the transaction data;
4) extracting necessary information and transferring it to the terminal as output; and
5) updating the internal data of the card.

7. The method of claim 5, wherein the financial card standard related data is EMV/PBOC standard related information.

8. The method of claim 5, wherein the message is an ISO 8583 message.

9. The method of claim 6, wherein the message is an ISO 8583 message.
